(19) United States
(12) Patent Application Publication
(10) Pub. No.: US 2018/0130138 A1
(43) Pub. Date: May 10, 2018

(54) GENERATING USER GROUPS IN A SOCIAL MEDIA SERVICE

(71) Applicant: Trimian, Inc., Menlo Park, CA (US)

(72) Inventor: Amit Kumar, Menlo Park, CA (US)

(21) Appl. No.: 15/798,798

(22) Filed: Oct. 31, 2017

Related U.S. Application Data
(60) Provisional application No. 62/415,721, filed on Nov. 1, 2016.

(51) Int. Cl. G06Q 50/00; H04L 12/58; H04L 29/08; G06F 17/30

(52) U.S. Cl. CPC G06Q 50/01; H04L 51/32; G06F 17/30867; H04L 67/306; H04L 67/22

(57) ABSTRACT

Systems, methods, and software described herein enhance the management of users and groups within a social media context. In one implementation, a user may request a generation of a new user group in a social media service. In response to the request, the social media service may receive attributes that the user desires to share with other members of the group. Once received, the social media service may identify one or more other users that share the attributes with the user, receive a message from the user to confirm the generation of the new user group, and provide the message to the one or more other users that share the attributes with the user.

### RELATED APPLICATIONS

This application claims the benefit of, and priority to, U.S. Provisional Patent Application No. 62/415,721, entitled “GENERATING USER GROUPS IN A SOCIAL MEDIA SERVICE”, filed Nov. 1, 2016, which is hereby incorporated by reference in its entirety for all purposes.

### BACKGROUND

A social media network is a mechanism that facilitates connection between people and information in an organized manner, which enables and facilitates the sharing of information between members of the social media network. Social media network services consist of a representation of each user (e.g., a profile), social links, and a variety of additional services. A large number of web-based social media networks exist (i.e., online social networks), which include services that allow users of the social media network to create a public profile, to create a list of users with whom to share connections, and to share and send messages throughout the network.

In some implementations, a social media network may permit users to generate groups from which other users may join to share messages, pictures, images, videos, and the like. For example, a user may generate a group regarding a topic of interest, and invite one or more additional users to the group. These users may then accept the invitation and initiate sharing with other members of the same group. However, although user generated groups may provide a forum for each of the users to communicate about like interests, it may be difficult for each of the users to manage the groups to which they belong. In particular, difficulties may arise in the administration and creation of the groups, as well as determining an efficient method for which other users can join the same group.

### OVERVIEW

The technology disclosed herein provides enhancements for managing users and groups of a social network. In one implementation, a method of operating a social media service to generate new user groups includes receiving a request from a first user to generate a new user group, and providing the first user with a plurality of attributes associated with the first user. The method further provides for receiving a selection of one or more attributes from the plurality of attributes, and identifying one or more other users in the social media service associated with the one or more attributes. The method also includes receiving a message from the first user to confirm the generation of the new user group, and transferring the message to the one or more other users to create the new user group.

This Overview is provided to introduce a selection of concepts in a simplified form that are further described below in the Technical Disclosure. It should be understood that this Overview is not intended to identify key features or essential features of the claimed subject matter, nor should it be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a social media network environment according to an implementation.

FIG. 2 illustrates an operation of a social media service according to an implementation.

FIG. 3A-3E illustrate social media user interfaces according to an implementation.

FIG. 4 illustrates an operation of a social media service according to an implementation.

FIGS. 5A-5B illustrate user interfaces following the creation of a new user profile according to an implementation.

FIG. 6 illustrates an operation of a social media service to provide selections to a member to generate a new group according to an implementation.

FIGS. 7A-7D illustrate user interfaces to generate a new group according to an implementation.

FIG. 8 illustrates an operation for group interaction within a social media service according to an implementation.

FIG. 9 illustrates a user interface for member interaction within a social media service according to an implementation.

FIG. 10 illustrates an operation of a social media service to provide group messaging according to an implementation.

FIGS. 11A-11C illustrate user interfaces to generate and view messages for groups of a social media service according to an implementation.

FIG. 12 illustrates a user interface indicating a feed for a social media service member according to an implementation.

FIG. 13 illustrates a social media computing system to manage a social media service according to an implementation.

### DETAILED DESCRIPTION

Examples, disclosed herein provide a social media network platform for efficient group creation and interaction. In particular, a social media network is a mechanism that facilitates connection between people and information in an organized manner. Social media services permit each of the members of the social network to generate a profile, and communicate with one or more other members of the social network. These communications may include text messages, images, videos, or any other type of media communication.

In the present implementation, a social media service is provided that permits users to join the social media service, and be associated to various groups based on attributes provided in generating the user profile. These attributes may include a school for the user, a job title for a user, an employer for the user, any interests associated with the user, or any other similar attribute information. Once the information is provided for the user profile, the user may be allocated to existing groups based on the provided attributes.

In some examples, in addition to being provided to previously existing groups, members of the social media service may further generate new groups. In particular, the user may select one or more attributes associated with their own profile to identify other members that share the same attributes or express interest in the same attributes. For example, a member may select a school and a job title to generate a new group of members that share the same attributes. Once selected, the creating member may send a message to generate the new group, and permit the other members with the same attributes to provide input to the group. This input may include responses to the message of the generating user, a new message thread for a new topic in the group, or some other input. Further, if a member is not interested in the created group, the member may be provided with preferences that permits the member from seeing future messages directed at the group.

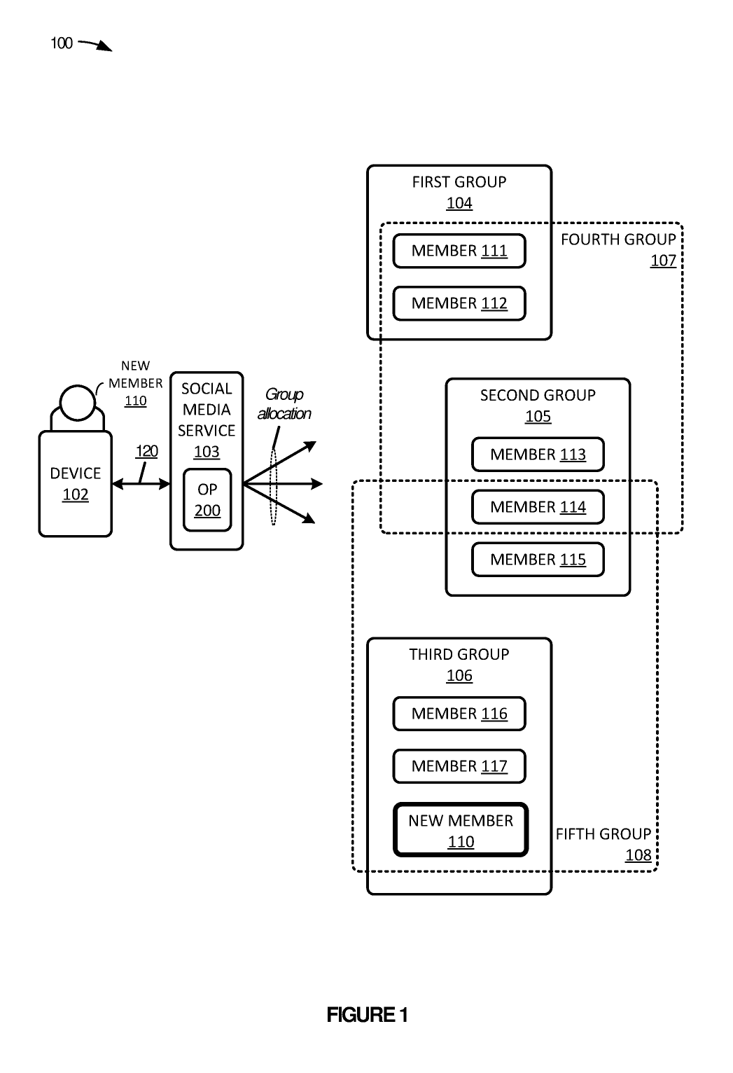

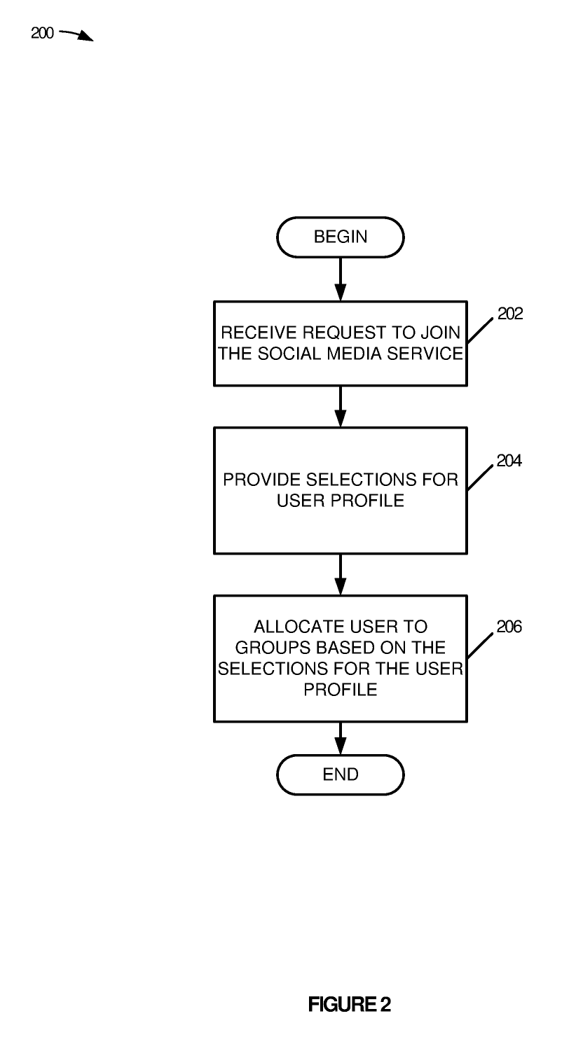

To further demonstrate the allocation of members to groups, FIG. 1 is provided. FIG. 1 illustrates a social media network environment 100 according to an implementation. Social media network environment 100 includes device 102 for new member 110, social media service 103, and member groups 104-108, which are managed by social media service 103. Device 102 communicates with social media service 103 via communication link 120. Social media service 103 is configured to provide operation 200, further described in FIG. 2, to allocate members to various groups within the social network.

As depicted, social media service 103 manages member groups 104-108 that permit members 111-117 to communicate with other members that share the same attributes. In particular, social media service 103 generates, with the assistance of information provided by the members, a profile for each of the members that includes various attributes associated with the user. These attributes may be related to schools that the member attended, a place of business for the member, a job title for the member, a current geographic location for the member, or any other similar interests of the member. Once attributes are identified, the member may be allocated or associated with specific groups that permit the member to chat with other members with similar qualified attributes.

Referring now to FIG. 2, FIG. 2 illustrates an operation 200 of social media service 103 according to an implementation. The operations in FIG. 2 are referenced parenthetically in the paragraphs that follow with reference to systems and objects of social media network environment 100 of FIG. 1.

As depicted in FIG. 2, operation 200 begins by social media service 103 receiving (202) a request to join the social media service. In some examples, to generate the request, new member 110 may instantiate the request on an application of device 102. This application may comprise a web browser capable of navigating to a web page provided by social media service 103, or may comprise a specific application for social media service 103. To initiate the request, new member 110 may be required to provide an email, a username, a first and last name, or some other similar identifier information for the user. For example, a user may provide an email with a .edu email address to join social media service 103.

Once the request is received by social media service 103, social media service 103 provides (204) selections for a user profile corresponding to new member 110. In some implementations, in providing the selections, social media service 103 may provide questions to the user in the form of a dialogue. These questions may be directed at determining a place of business for the new member, a type of degree for the new member, a current work position for the new member, interests of the new member, or some other similar question related to identifying attributes about the end user. In at least one example, in providing the questions via the dialogue, as the user provides responses to the questions, the questions may be auto-filled with predicted information. This predictive information for the auto-fill may be generated from previous user responses to the same questions, but may also be generated based on public information gathered from other websites and databases. For example, social media service 103 may search other social media networks to determine information about users that may join the social media service 103. Based on the gathered information, social media service 103 may be capable of predicting the information provided by a new member when they request to join the network.

After the user provides the responses to the user profile dialogue, new member 110 may be allocated (206) to groups based on the selections for the user profile. Here, new member 110 is allocated to third group 106 and fifth group 108. These groups may permit the new member to communicate with other users within the groups, identify the other members within the group, share objects (such as images and files) with other members of the group, or other similar operations with other members of the group.

In some implementations, in joining social media service 103, new member 110 may be required to be verified by another member of the social media service. This verification may be used to ensure that the information provided by the member is accurate, and that users are only placed with appropriate groups of other members. For example, when new member 110 requests to join the social media service, a profile may be generated and the user placed in groups with other members. However, the user may be placed in a probationary state that limits the interaction with other users, until another approved user verifies the account. This probationary state may prevent the user from messaging other members of the group, sharing files with any members of the group, or any other similar limits on the interaction with other members. In some examples, the probationary members may also appear different than users who have been verified via a visual indicator on their user profile.

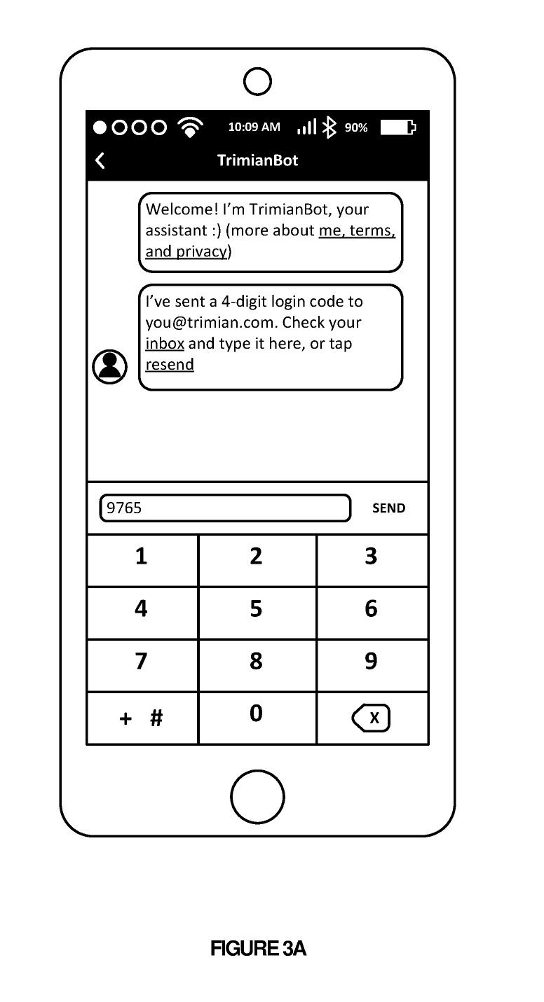

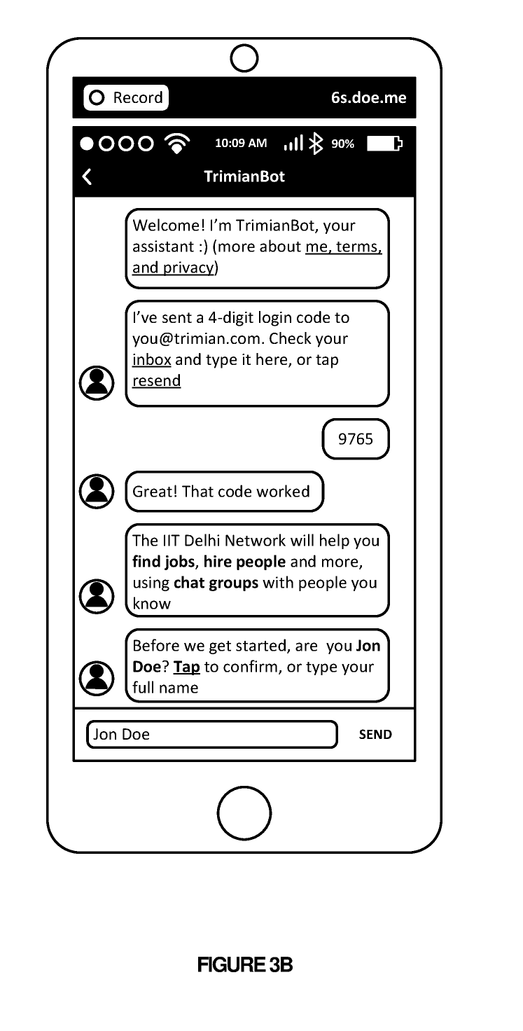

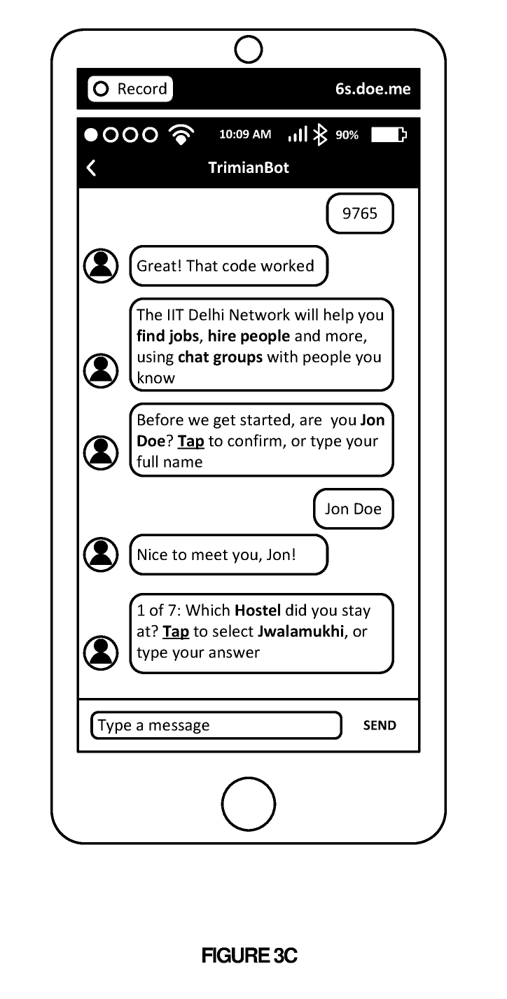

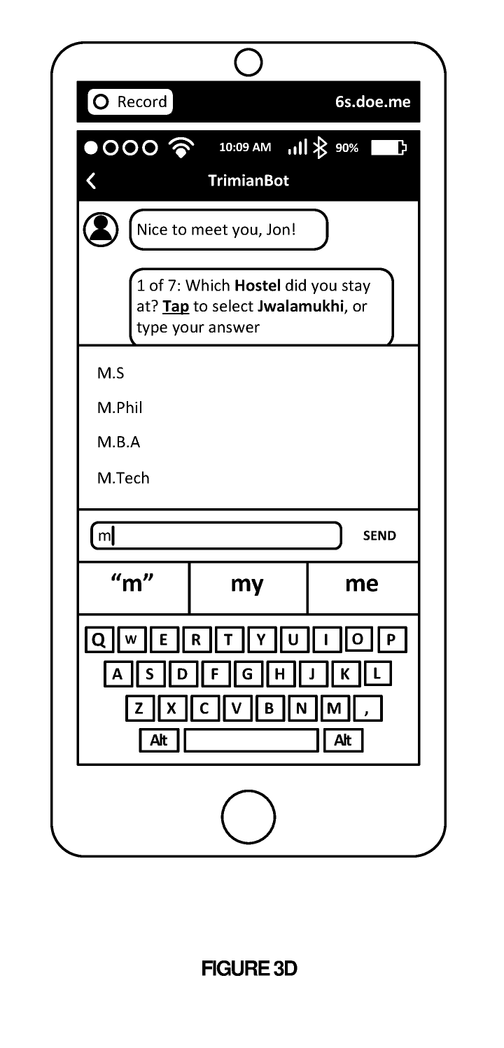

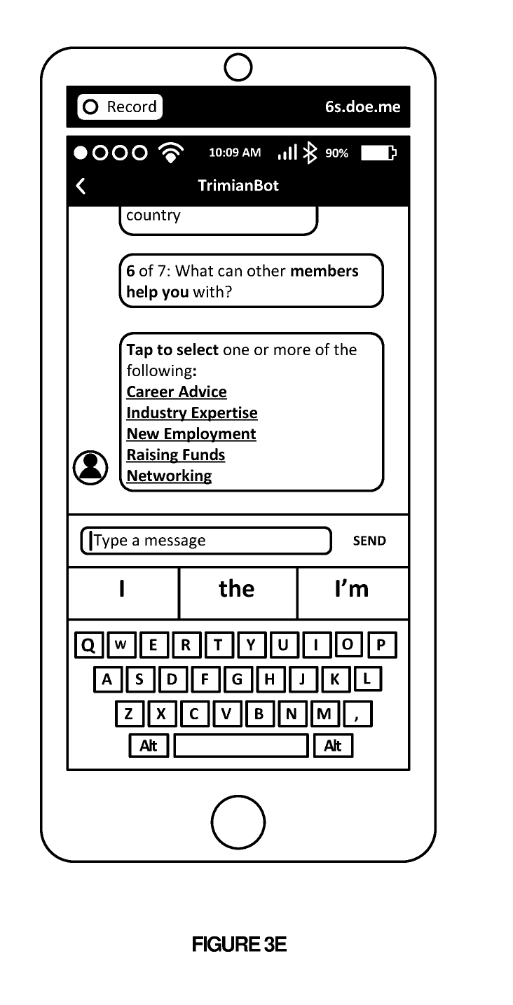

FIGS. 3A-3E illustrate social media user interfaces according to an implementation. FIGS. 3A-3E are representative of an exchange between a new member and a social media service to generate a profile for the end user. In some examples, information only may be provided to the local device of the end user by the social media service, wherein the local device may be responsible for generating a display based on the provided information. In other implementations, visual display information may be provided by social media service for display on the local device. Although illustrated in the examples of FIGS. 3A-3E using a mobile device with a user interface touchscreen, it should be understood that similar displays may be provided on desktop computing systems, laptop computing systems, or any other similar computing system with an input/output user interface.

Referring first to FIG. 3A, when a new user requests to join the social media service, the social media service may present a dialogue to the new user to determine information about the user. For example, in a browser or in an application specific to the social media service, the user may provide an email, a username, a first name, a last name, or some other similar identifier for the user. Once provided, the social media service may provide the user with a series of questions in the form of a dialogue to determine additional information and attributes about the user. Here, in FIG. 3A, the user is first required to provide a login code to verify the email that was used in generating the new profile. Once the code is provided, the user may be presented with secondary questions to generate the complete profile. As illustrated in FIGS. 3B-3E, these questions may include verifying your name, verifying where you stayed when in school, and any career information, including career interests or what you can help other members with. Although sample questions are illustrated in FIGS. 3B-3E, it should be understood that other questions may be provided in addition to or in place of the illustrated questions. These questions may be related to the member's major in school, the current position held at an organization, a current location for the new member, or any other similar information.

In some examples, such as that illustrated in FIG. 3D, as a user attempts to enter information, the social media service may autofill responses to questions, permitting the user to more quickly enter the required field. To populate the autofill options, the social media service may use information that was provided from other users, and provide the options based on the popularity of selections. These selections may also change as more information is typed by the user. For example, when a first letter is entered, the user may be provided with a first set of autofill options. However, as additional letters are entered by the user, a different set of autofill options may be made available to the user. In some examples, in generating the autofill information, the information may be provided at least in part based on public information identified from other websites or databases. For example, the social media service may search other social networks to determine information about a particular user. This information may then be suggested in the autofill portion of the text box, permitting the user to select and verify the information.

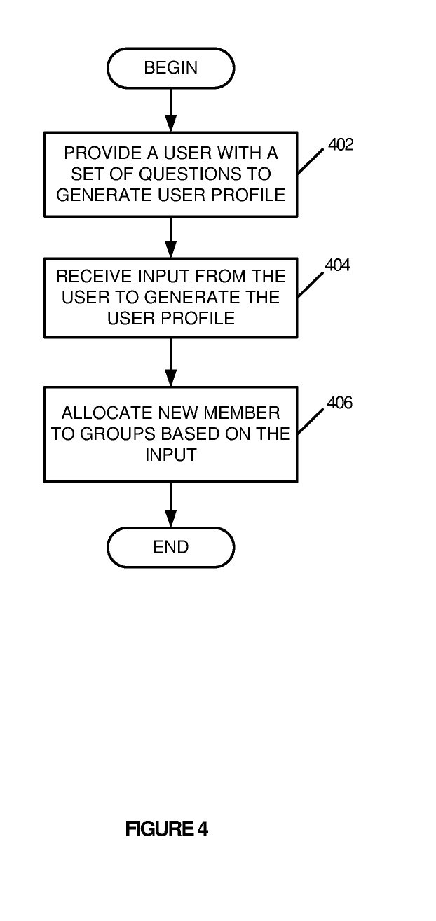

Referring now to FIG. 4, FIG. 4 illustrates an operation of a social media service according to an implementation. The operations in FIG. 4 are referenced parenthetically in the paragraphs that follow with reference to systems and objects of social media network environment 100 of FIG. 1.

As described herein, when a user requests to join social media service 103, the user may be provided with a dialogue to generate a member profile associated with the new member. In particular, once a request is received, social media service 103 may provide (402) a user with a set of questions to generate the user profile. These questions may be provided as group of questions or may be provided one at a time, such as the dialogue examples in FIGS. 3A-3E. As the questions are provided, either to an application or a web browser on device 102, social media service 103 receives (404) input from member 110 to generate the user profile associated with the new member. To receive the input data, the application or browser on device 102, may be configured to receive input from the user to respond to the questions provided via a user interface on 102. In some examples, the input data may comprise natural language input, which can be provided using a keyboard or speech interface on the device. In a particular instance, the keyboard may permit member 110 to enter words, phrases, names, and other information in response to the provided questions. Additionally, social media service 103 may provide the user with suggested or predicted responses to improve and expedite the generation of the new member profile. In some examples, the predicted responses may be generated based on the information provided by members that previously joined the network. In other examples, in addition to or in place of the information from previously joined members, social media service 103 may use public information from other websites, such as social media service websites, to generate the suggestions for the end user. Further, suggestions may be made based on previous input of the end user. For example, a major may be suggested based on job title provided by the member. Similarly, suggestions may be modified as the input from the user is received. As a result, as the member types into the response field to the questions, suggestions may be made and modified based on the letters or terms provided by the new member.

In some examples, the questions that are provided to the new member may be the same for all of the new members. However, in some examples, the questions that are provided to the new member may be changed based on answers to previous questions. For example, a first question may ask a place of business for the new member. Based on the response to the question, social media service 103 may determine a next question that relates to the place of business provided by the new member.

As the information is received from device 102 and provided to the social media service 103, social media service 103 may allocate (406) the new member to groups within the social media service, wherein the groups are allocated based on traits or attributes of the individual. For example, the groups may be separated based on job title, company, location, or some other similar attribute information identified via the questions provided in the profile generation. These groups may further be refined to include multiple attributes. Thus, a new member may be placed within a group based on the current location and profession, or the current location and purpose for joining the network. Referring to the example of FIG. 1, new member 110 is allocated to third group 106, which is a sub-group of fifth group 108.

Although these are the initial groups that are provided to new member 110, it should be understood that new groups may be generated once new member 110 is added to the social media service. These new groups may be created by new member 110 or may be generated by some other member of the social media service, wherein new member 110 may be added to the group based on attributes specified by the other member in the generation of the group. Further, although initial questions may be provided to a new member to generate the first version of the member profile, it should be understood that additional information may be provided by the member to identify additional attributes of the member. These attributes may be self-defined by the user, or may be added based on a second set of questions being provided to the new member.

In some implementations, instead of relying on the users to generate new groups, it should be understood that social media service 103 may automate the process of generating groups. In particular, social media service 103 may monitor the attributes in each of the users' profiles and determine when users that share attributes meet group generation criteria. For example, when a first user joins the service, the first user may be the only electrical engineer within a defined geographical region. However, over time and as more users move or join the service, then social media service 103 may identify that more users share the electrical engineer and geographical location attribute, and generate a new group based on the new users sharing the attributes. In at least one example, social media service 103 may monitor the attributes of the users of the service, identify two or more users that share at least one attribute, determine whether the two or more users meet group generation criteria and, if the two or more users meet group generation criteria, generate a new group for the two or more users and provide a notification of the new group to the two or more users. This providing of the notification may include an express notification, or may add the new group to a list groups for each end user. In addition, once a new group is generated, new users and users that update their profile may be added to the group, permitting the exchange of messages and media with other users within the group.

In some examples, to determine whether the one or more users meet group generation criteria, social media service 103 may determine whether the quantity of users with the shared attributes meet defined criteria, whether the users for the group are active in the social media service, whether a quantity of shared attributes meet defined criteria, or some other criteria, including combinations thereof. In some instances, the social media service may further monitor interactions and messages communicated within the service, wherein the monitoring may be used to determine whether users should be defined as a new group. For example, when users are identified that share attributes, messages and other interactions may be used to determine whether the users meet group generation criteria, such as content in messages, current groups for the users, or some other interaction information for the users.

Although not illustrated in the example of FIG. 1, it should be understood that each member/user of social media service 103 may communicate with the social media service in a similar manner to that of new member 110 and device 102. In particular, the other members may use mobile devices, desktop computing systems, and the like to retrieve required information and access services provided by social media service 103.

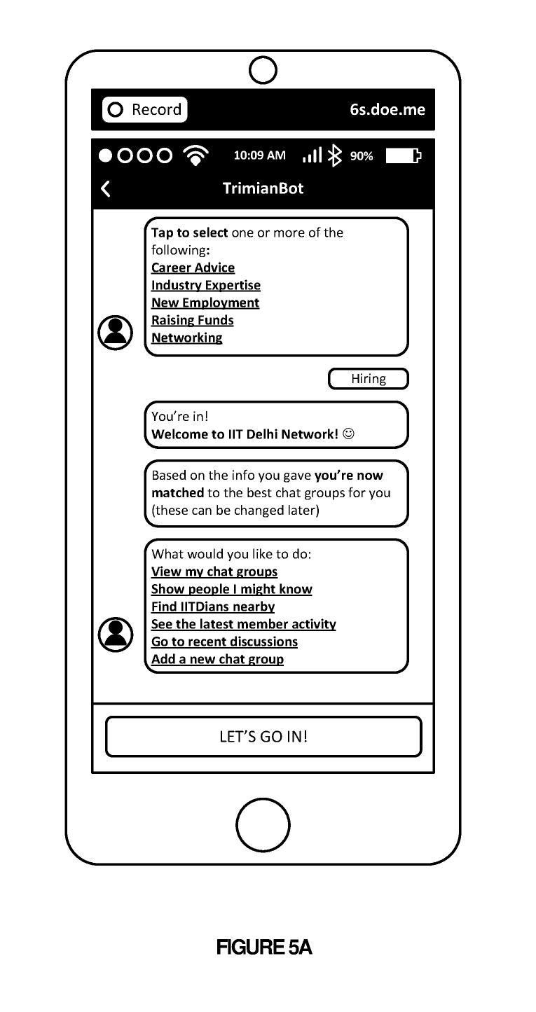

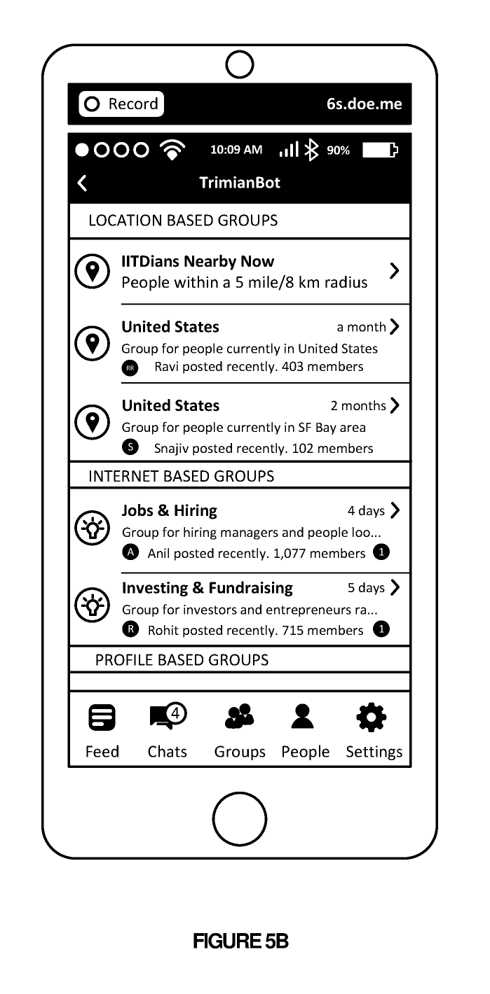

FIGS. 5A-5B illustrate user interfaces following the creation of a new user profile according to an implementation. FIGS. 5A and 5B are illustrated on a mobile device with a visual interface and touch-based user interface, however, it should be understood that an input/output interfaces may be provided on a desktop, laptop, or some other computing device to output information for the social media service and receive input from the end user. In some examples, information only may be provided to the local device of the end user by the social media service, wherein the local device may be responsible for generating a display based on the provided information. In other implementations, visual display information may be provided by social media service for display on the local device.

As described herein, a social media service may be configured to retrieve attributes and traits for a new member of the service. These attributes may be defined via a communication exchange, wherein the service provides questions to the new member and the new member responds to the questions to generate the user profile. Once the questions are answered, the profile may be generated, and the user provided with available actions within the social media service. Here, as depicted in FIG. 5A, the user may be provided with option to view my chat groups, show people that I might know, find other members of the same school, see the latest member activity, go to recent discussions, or add a new chat group. From this interface, the user may select an option, and be provided with a new user interface associated with the selection. For example, if the user selected “view my chat groups,” then the user may be provided with a new user interface by the social media service indicating groups with which the user belongs.

Referring to FIG. 5B, is an example of a user interface that might be provided if the user made the “view my chat groups” selection. Here, the groups include location based groups which includes members within various distances of the member, interest based groups, which are determined based on interests selected by the user when generating the member profile, and a profile based group, which is based on other attributes of the member when generating the member profile. In addition to the various groups, the member may also be provided with other options within the social media page, including moving to a “feed” of the current activities of members in the social network, “chats” for chats in the social network including those initiated by the member, “groups” to view and generate new groups for the social media service, “people” to find and invite new people in the service, and “settings” to adjust notifications, profile information, and the like.

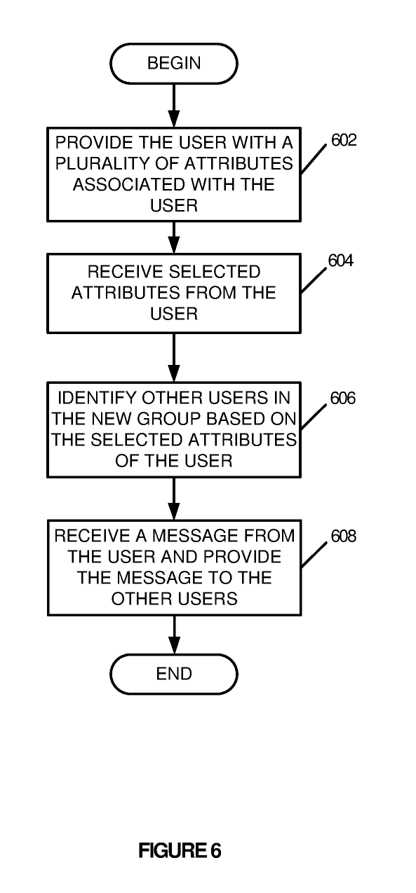

FIG. 6 illustrates an operation of a social media service to provide selections to a member to generate a new group according to an implementation. The operations of FIG. 6 are referenced parenthetically in the paragraphs that follow.

As depicted in FIG. 6, once a member joins the social media service, the user may navigate a social media application or browser to perform different functions in relation to the social media service. In the present example, the member may desire to add or generate a new group of members based on specific attributes. To support the request, the social media service may provide (602) the user with a plurality of attributes associated with the user. These attributes may include traits or attributes for the user which are defined in generating the user profile. For example, the attributes may comprise job position attributes, education history attributes, interest attributes, and location attributes, among other attributes of the creating end user. Once the available attributes are provided to the creating user, the social media service may receive (604) selected properties from the user. Referring to the example attributes above, the user may select to create a group within the same geographic location with the same job title.

Once the selections are received, the social media service will identify (606) one or more other users or members of the social media service associated with the one or more attributes defined by the requesting user. Once the other users are identified, the social media service may receive (608) a message from the user to confirm the generation of the new user group, and provide the message to other members within the group, wherein the message may comprise text, an image, a video, or some other similar content. In some examples, in providing the message to the other members of the group, the message may be transferred to the devices of the other members as the members access the social media service via a browser or a standalone application. Once provided to the other users, the other users may respond to the original message thread, or generate a new message thread for the user group. In some examples, if a message comprises a response to the original message thread, an indication may be included that specifies that the message is a response to the first thread. Accordingly, the indication may be used in displaying the response message as a sub-thread to the original message. Additionally, once created, the new group may be added to the list of previously existing groups in chat list for the creating user, as well as other members of the newly created group.

In some examples, once the selections are provided for the new group and the other users for the group are identified, the social media service may provide membership information for other members in the new group to generating member. In at least one implementation, in providing the membership information, the social media service may provide the requesting member with the quantity of new users in the group, the names of the users in the new group, or any other similar information, including combinations thereof. Based on the information, the member creating the group may determine that the group is as desired, and communicate the first message to the group, which notifies the other qualifying members of the group about the creation of the group. In other implementations, if the creating member decides that the users within the group are not desirable, then the creating member may modify the attributes of the users within the group or cancel the creation of the group. In at least one instance, the social media service may advise a creating user that the user group is too large when the quantity of users in the group meet certain criteria. Based on the notification, the generating user may select additional attributes to decrease the number of users included within the group. For example, the user may reduce the geographic region for users that qualify for the group.

In some examples, when the user sends an initial message to create the group, the other users that qualify for the group may select to accept the invitation to the new group or, in the alternative, may select to be removed from the particular group to prevent viewing future notifications to the group. Although these are two options in responding to the creation of a new group, it should be understood that other options may be provided to members of a newly created group. For example, a member may only be joined or notified of a new group when enough interaction has occurred within the group, such as a defined number of messages, a defined number of members providing input to the group, or some other similar event.

In some implementations, when a user selects to generate a new group, a group may already exist with the same shared attributes. As a result, the social media service may be configured to identify that the group already exists and provide the requesting user at the user device with a messaging interface for the previously generated group. This messaging interface may include messages from other users in the group, such as text, picture, and video messages, or any other similar content shared between members of the preexisting group.

Although illustrated in the previous example with a user generating a new group within the social media service, it should be understood that the service itself may be used to automate the process of generating a group. In particular, the social media service may monitor the attributes associated with each of the users in the social media service, wherein the attributes may include schools of graduation, places of business, current occupation, location (which may be determined via global positioning information from the user device), or some other similar profile attribute. While monitoring the attributes of the users, the social media service may identify two or more users that share at least one attribute or have at least one attribute in common. For example, users may share a current geographic location and a job title. Once the two or more users are identified, the social media service will determine whether the two or more users meet new group generation criteria. This determination may include determining whether the quantity of users sharing the same attribute exceed a quantity threshold, whether the users in the new group meet activity criteria within the environment (such as a number of messages about a particular topic, a number of messages with other users that would also qualify for the group, etc.), whether the quantity of shared attributes meet attribute criteria, or some other similar criteria in relation to the users and/or shared attributes, including combinations thereof. If it is determined that that the two or more users fail to meet the new group generation criteria, then a new group will not be generated. However, if it is determined that the two or more users meet the new group generation criteria, then a new group may be generated. Once generated, a notification may be provided to the users of the group, and the users may exchange text and media messages with other members in the user group.

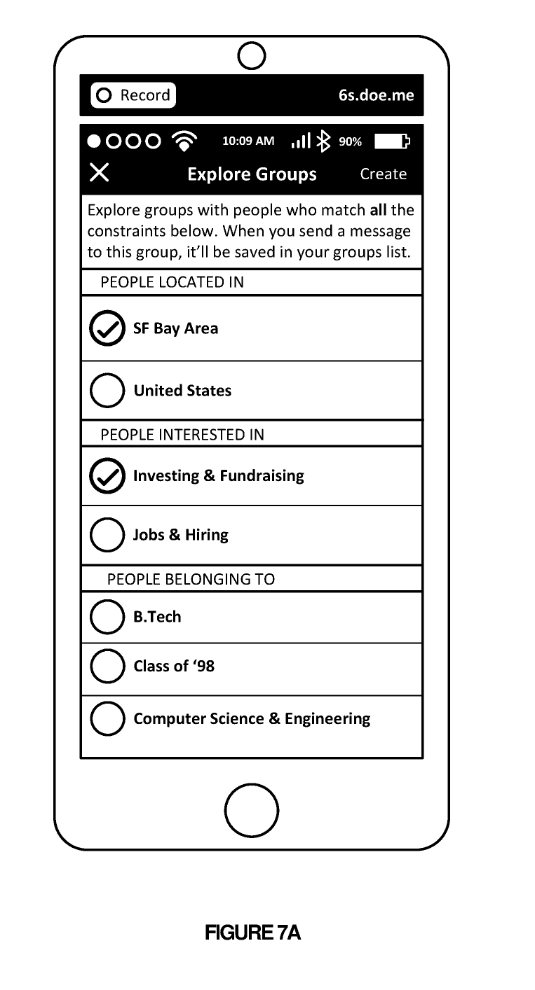

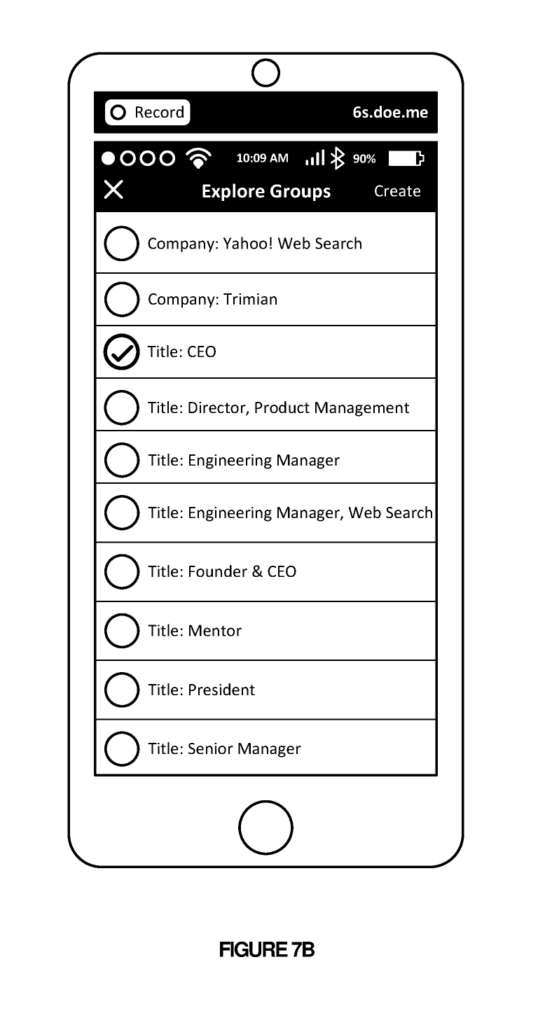

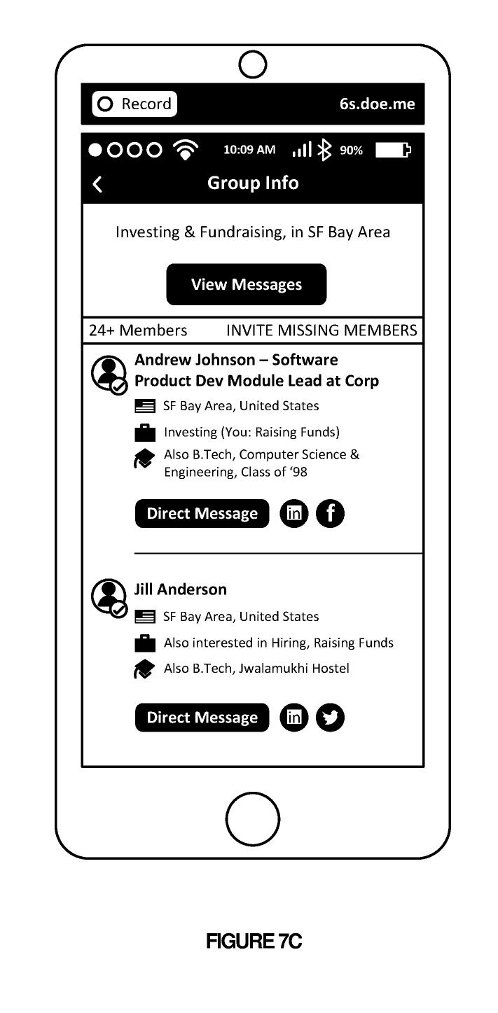

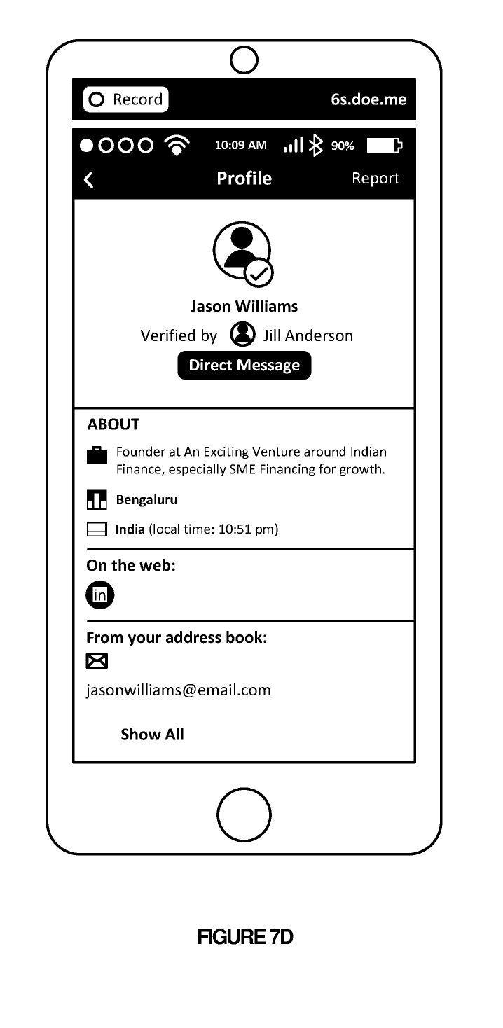

FIGS. 7A-7D illustrate user interfaces to generate a new group according to an implementation. As described herein, once a user has become a member of the social media service, the social media service may provide options to the user, permitting the user to interact with other members in the social media service. Here, the social media service permits a user to generate a new group based on attributes that are relevant to the particular user. Although illustrated in the examples of FIGS. 7A-7D with a mobile device, it should be understood that similar interfaces may be provided on desktop computing systems, laptop computing systems, or any other end user computing system. In some examples, information only may be provided to the local device of the end user by the social media service, wherein the local device may be responsible for generating a display based on the provided information. In other implementations, visual display information may be provided by social media service for display on the local device.

Referring first to FIG. 7A, when a user selects to generate a new group, the user may be provided with a list of attributes that correspond to the particular user. These attributes may be used in defining the shared attributes that other users must have in common with the creating user to be included within the group. In the example of FIG. 7A, the user may select a location of interest, a business interest (investing and fundraising, jobs and hiring, etc.), and people belonging to a particular relevant group (such as a graduating class, major, and the like). Although only seven different options are provided in FIG. 7A, it should be understood that any number of selections may be provided to the user to define the attributes of a particular group. Specifically, referring to FIG. 7B, the user may further be provided, by scrolling or some other interface, with additional attributes, such as a company, a job title, or some other attribute that the user desires to have in common with other users of the same group.

Once the traits are selected, a group summary may be generated and provided to the user. Referring to FIG. 7C, the user may be provided with a summary that indicates the number of users, the names of the users, or any other similar information about the users of the group, including combinations thereof. From this user interface, the user may select to generate a new message to create the new group and provide the message to other users in the group, select a particular user within the group, or return to the previous page to add, remove, or modify the attributes that define the group. In at least one example, when the user selects a member of the group they may be provided a profile view of the user, such as that provided in FIG. 7D. This profile view may include an image for the user, information about the user, such as location, current company, job position, and the like, and may further provide contact information for the user. Although these are just some examples, it should be understood that any attribute related to the selected user may be provided within the profile.

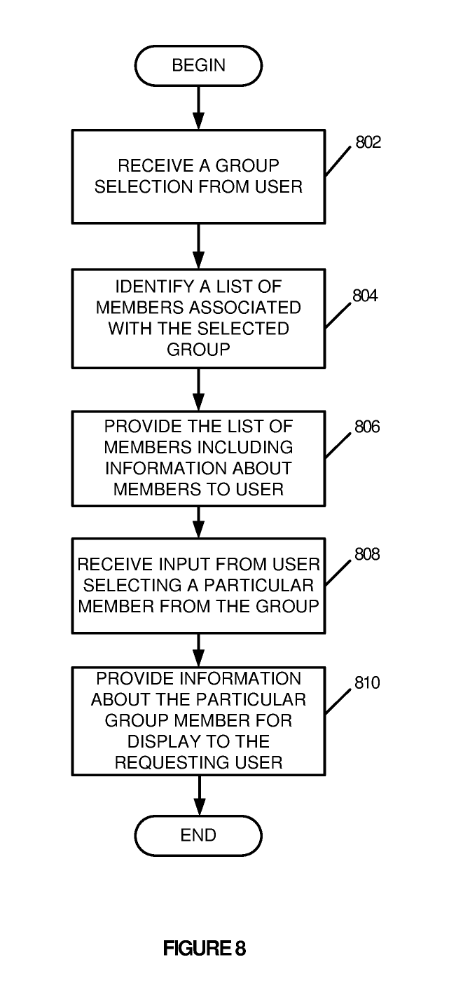

FIG. 8 illustrates an operation for group interaction within a social media service according to an implementation. The operations of FIG. 8 are referenced parenthetically in the paragraphs that follow.

As described herein, once a user generates a user profile, the user may access and various services provided by a social media service. One such service includes monitoring and managing the groups that the user belongs. In particular, a user interface may be provided to the user at the end user device permitting the user to receive (802) a selection of a group from a user. In some implementations, the group may comprise a currently existing group with at least one message exchanged between the members of the group. In other examples, the selection of the group may comprise a new group defined by one or more desired attributes from the user as further described in FIG. 6.

Once the group is selected, the social media service will identify (804) a list of members associated with the selected group, and provide (806) the list of members including information about the members for display to the requesting user. This display of the list of members may include the names of the users, the occupations of the users, like interests with the user requesting the information about the group, a current company for each of the members, or some other similar attribute, including combinations thereof. After displaying the list of members within the group, the service may receive (808) input from the user selecting a particular member from the group and, once selected, may provide (810) information about the particular member for display on the user device. In some implementations, once a member is selected, the social media service may provide a profile page view for the selected member. This profile page may include additional information about the member that could not be displayed in the group list. In particular, it may include a work history portion, methods to contact that particular member, or any other supplementary information about the selected member.

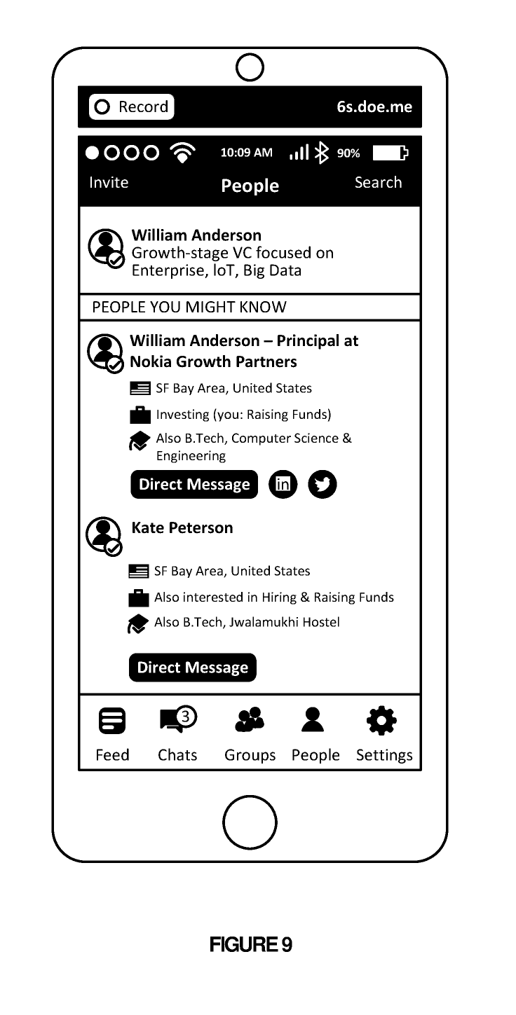

Turning to FIG. 9, FIG. 9 illustrates a user interface for member interaction within a social media service according to an implementation. As depicted, once a user becomes a member of a social media service, the user may then search for and/or be suggested with people that they might know, permitting the user to communicate with the particular members. Here, for user William Anderson, a list of members is provided for people that the user may know. This list may be derived from attributes associated with the user in comparison with other members of the social media service. In particular, the social media service may compare information in each profile to the information in the requesting users profile. Based on the comparison, and in some examples a score generated for each of the members, the members may be provided as a list to the requesting end user.

In some implementations, the user may have an option to modify the list that is provided, wherein the user can promote certain types of members, such as members that went to the same university, or may demote some members, such as members that work in a field that is not of interest to the user. To make modify the list, in some examples, the user selects the user of interest from the list, and promotes or demotes particular attributes or the entire user. In other examples, in addition to or in place of modifying the list itself, the user may enter a settings menu where the user can select particular attributes that are not of interest to the user. Based on the information provided, by either promoting or demoting members/attributes, a new list may be provided to the requesting user.

In some implementations, the list of members that are provided to a requesting user may also include users that have not yet joined the social media service. In particular, as described herein, the social media service may search and scan other publicly available social media networks and databases to derive user profiles for users that have not yet joined the service. As a result, the social media service may provide communication means for each of the users based on the search, and may further provide the option for a user to invite the non-joined member to join the social media service. Accordingly, in addition to suggesting users that are members of the service, the social media service may compare attributes gathered from other sites about a potential user to a current user to determine whether or not a suggestions should be made for the current user.

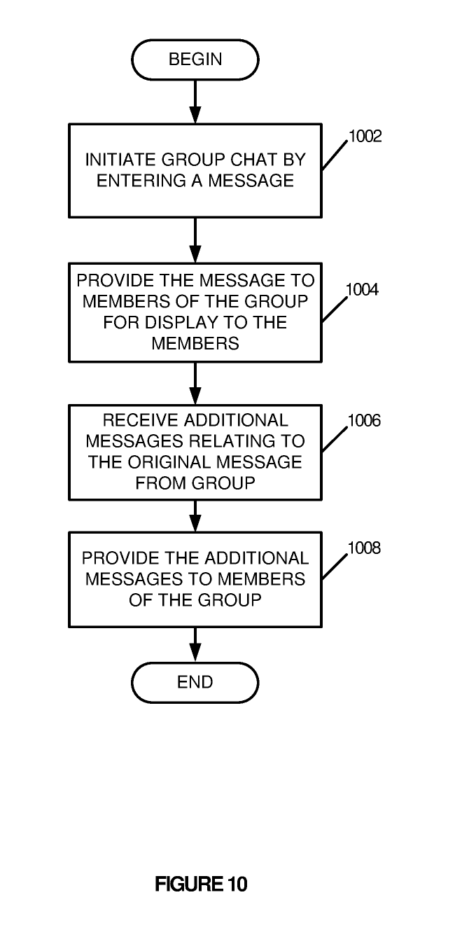

FIG. 10 illustrates an operation of a social media service to provide group messaging according to an implementation. The operations of FIG. 8 are referenced parenthetically in the paragraphs that follow.

As described herein, once a user becomes a member of the social media network, the user may desire to communicate with other users within particular groups. To communicate within the groups, the user may initiate (1002) a group chat by entering a message within a message dialogue box for the particular group. In at least one implementation, the user may be provided with a list of groups that the user belongs. Based on the list, the user may select a particular group, and enter a message to be supplied to other users associated with the same group. In at least one example, the messaging for a particular group may be divided into tiers of messages, wherein an initial message (or initial thread) may comprise the first tier, and response messages to the initial message may be divided into smaller sub-tiers. These sub-tiers may be indicated by indenting beneath the first message on a particular topic, by branching out to a second user interface specific to the topic, or some other method of defining the sub-tiers. Accordingly, messages that are responses include an indication of which message they are in response to.

Once the group chat is initiated, the service may provide (1004) the message to members of the group for display in the group chat interface on the members' devices. Once displayed, the service may receive (1006) additional messages from the members related to the original message for the group. For example, if the first message asked for recommendations to fill a programming position, then the messages from the other members may indicate persons that they believe could fulfill the request. As the messages are received, the service may provide (1008) the additional messages to members of the group.

In some implementations, as described herein, a first message in a first tier may receive responses in one or more sub-tiers. Consequently, once the first user generates the first message, other members may select that particular message and indicate that they desire to make a response. As a result, rather than being viewed as a new topic, responses may be made viewable in such a manner to indicate that they are responses to the original message. In the alternative, if a user does not desire to make a message a response, the user may initiate a new message thread from which other users may selectively respond.

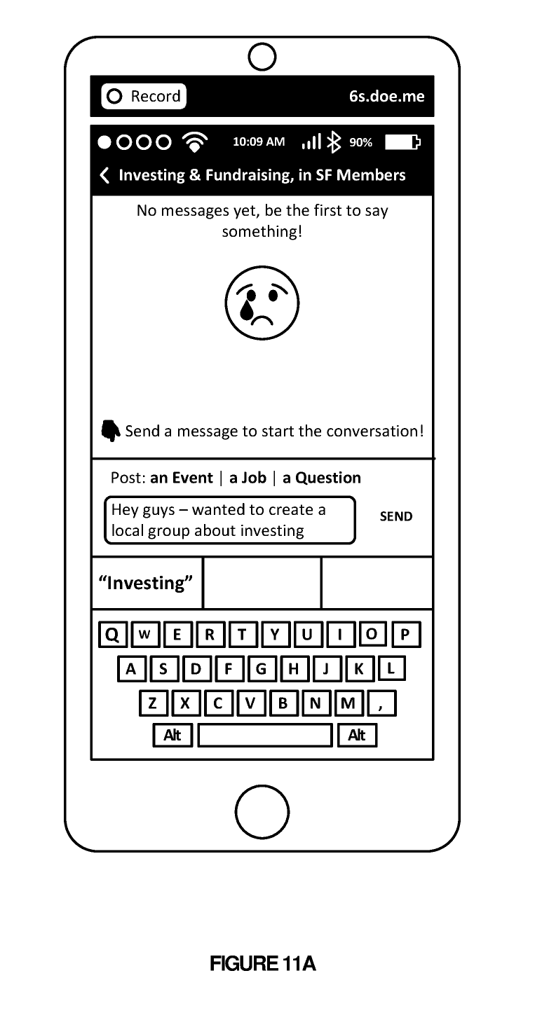

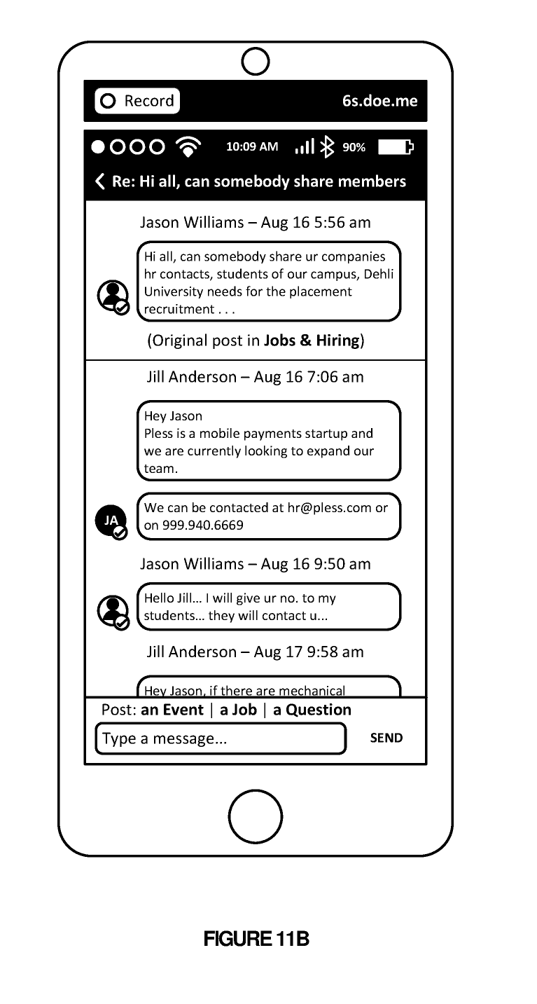

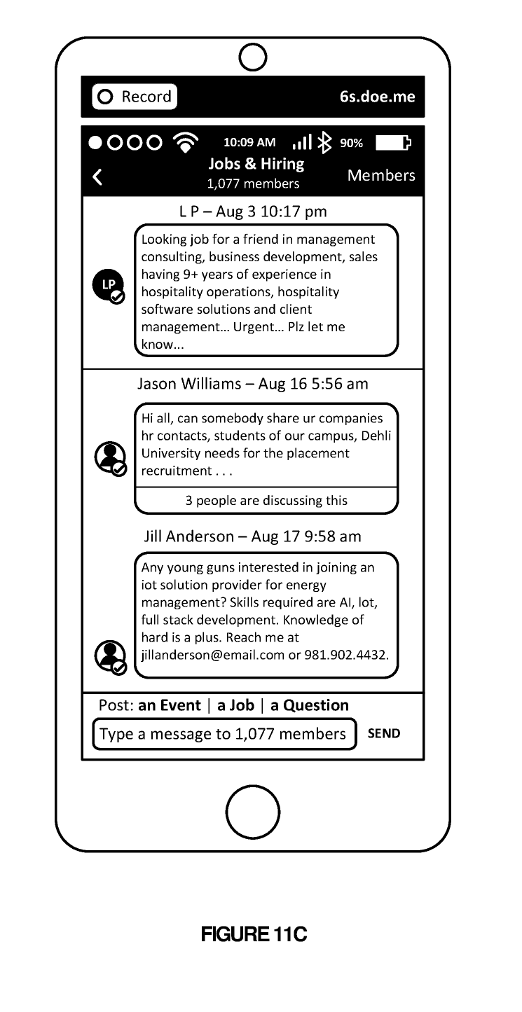

FIGS. 11A-11C illustrate user interfaces to generate and view messages for groups of a social media service according to an implementation. Although illustrated on a mobile device in the examples of FIGS. 11A-11C, it should be understood that similar displays may be made on desktop computers, laptop computers, and the like via a designated social media application or a web browser.

Referring first to FIG. 11A, FIG. 11A illustrates a user interface operation to provide an initial message in a group communication. In some examples, this initial message may occur when a user first generates a new group and is required to provide a first message to members of the group to complete the creation of the group. Here, because the user has generated a new group, there are no messages to display. Instead, the user is provided with a text box and accompanying keyboard to enter the first message. Once entered and the user elects to send, the social media service will forward the message to other users of the same group.

As demonstrated in the example of FIG. 11A, in addition to supplying the text for a particular message, the user may also highlight a particular topic for the message. This topic may be placed with the message when it is posted, may be used in generating a color of the message when it is posted, or may be used in providing any other similar context with respect to the message. For example, if the user created an event, the text in the group messaging window may appear in a first color, whereas if the user posted a message about a job, then the text may appear in the group messaging window in a second color. This may more easily allow other users in the group to identify messages that are relevant to them.

While illustrated as entering a first new message thread for a group, it should be understood that similar operations may be provided for initiating a new message thread to be added to preexisting message threads. For example, if previous messages did not provide the questioning or comments that a user desired, then the user may develop a new message and submit the message to other users in the group.

Turning to FIG. 11B, FIG. 11B demonstrates a user interface to develop a response to previous message. As depicted, an original message may be selected by a user to expand the message and view the responses generated by other users. Here, the initial message is highlighted at the top using the terms “Original Post in Jobs & Hiring.” Below the original message, users may view the responses to the particular message, as well as respond to the message themselves. In some examples, in generating the response the user may respond to the original post, but may also respond to one of the previous responses. In particular, the user may select one of the responses, which may again expand into a sub-thread with the selected response as the original message. Accordingly, form a single original post, sub-threads may be created based on the responses.

Referring to FIG. 11C, FIG. 11C demonstrates a user interface for sub-threads to an original group message. Here, the second message from “Jason Williams” indicates that three people are talking about a particular response. Based on the information provided, a user may select that particular response due to the popularity, and either read the messages from the three people in the discussion or add input to the discussion. Although a single message includes an indication of the number of people discussing the message, it should be understood that each of the messages within a chat group may indicate the number of people talking about the particular topic. Further, while illustrated with a quantity for each message, it should be understood that colors or other shading techniques may be used to highlight messages that are receiving more responses. This highlighting may be done based on the number of messages and/or number of users posting to the thread over a particular time period.

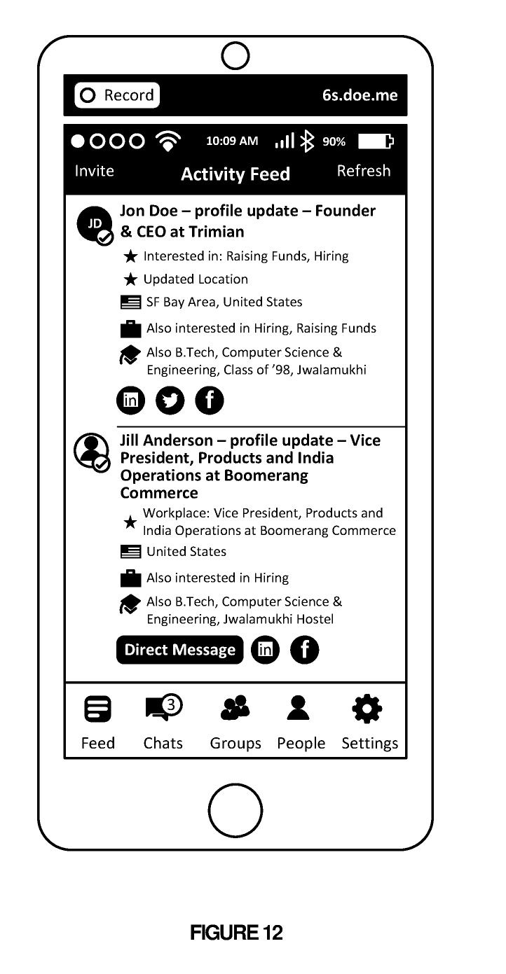

FIG. 12 illustrates a user interface indicating a feed for a social media service member according to an implementation. Although illustrated on a mobile device in the example of FIG. 12, it should be understood that similar displays may be made on desktop computers, laptop computers, and the like via a designated social media application or a web browser.

As depicted, a user of a social media service may be provided with a feed that can be used to update the user on the activities of others on the network. These activities may be ordered based on when the activity occurred, the interest level that the user has in the activity, the interest level that the user has in the member associated with the activity, or some other similar method of ordering. These interests may be based on previous selections by the user, such as whether the user clicked on the feed following a particular post to the feed, or may be based on profile settings created explicitly by the user. Here, stars indicate what activity occurred for each of the users. In particular, John Doe modified his interests and his location, while Jill Anderson updated her work place.

In addition to providing a user with the items that were changed, the feed may also be used to provide modes of communication with the various users. These modes may include a direct message using the social media service, but may also link to the users' other social media profiles. Although illustrated in the feed example of FIG. 12 as people updating their profiles, it should be understood that other information may be provided in the feed. This information may include when a member sends a message in a group that the user also belongs, a member responding to a previous message generated by the user, or some other similar event related to the user.

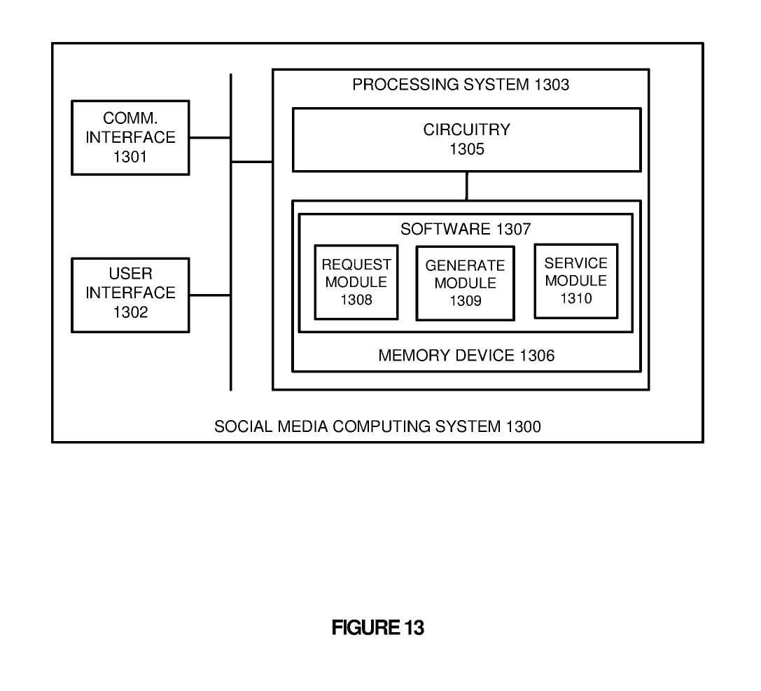

FIG. 13 illustrates a social media computing system 1300 to manage a social media service according to an implementation. Computing system 1300 is representative of any computing system or systems with which the various operational architectures, processes, scenarios, and sequences disclosed herein for providing a social media service. Computing system 1300 is an example of social media service 103, although other examples may exist. Computing system 1300 comprises communication interface 1301, user interface 1302, and processing system 1303. Processing system 1303 is linked to communication interface 1301 and user interface 1302. Processing system 1303 includes processing circuitry 1305 and memory device 1306 that stores operating software 1307. Computing system 1300 may include other well-known components such as a battery and enclosure that are not shown for clarity. Computing system 1300 may comprise one or more server computers, desktop computers, laptop computers, or some other similar computing devices.

Communication interface 1301 comprises components that communicate over communication links, such as network cards, ports, radio frequency (RF), processing circuitry and software, or some other communication devices. Communication interface 1301 may be configured to communicate over metallic, wireless, or optical links. Communication interface 1301 may be configured to use Time Division Multiplex (TDM), Internet Protocol (IP), Ethernet, optical networking, wireless protocols, communication signaling, or some other communication format—including combinations thereof.

User interface 1302 comprises components that interact with a user to receive user inputs and to present media and/or information. User interface 1302 may include a speaker, microphone, buttons, lights, display screen, touch screen, touch pad, scroll wheel, communication port, or some other user input/output apparatus—including combinations thereof. User interface 1302 may be omitted in some examples,

Processing circuitry 1305 comprises microprocessor and other circuitry that retrieves and executes operating software 1307 from memory device 1306. Memory device 1306 may include volatile and nonvolatile, removable and non-removable media implemented in any method or technology for storage of information, such as computer readable instructions, data structures, program modules, or other data. Memory device 1306 may be implemented as a single storage device, but may also be implemented across multiple storage devices or sub-systems. Memory device 1306 may comprise additional elements, such as a controller to read operating software 1307. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 1305 is typically mounted on a circuit board that may also hold memory device 1306 and portions of communication interface 1301 and user interface 1302. Operating software 1307 comprises computer programs, firmware, or some other form of machine-readable program instructions. Operating software 1307 includes request module 1308, generate module 1309, and service module 1310, although any number of software modules may provide the same operation. Operating software 1307 may further include an operating system, utilities, drivers, network interfaces, applications, or some other type of software. When executed by processing circuitry 1305, operating software 1307 directs processing system 1303 to operate computing system 1300 as described herein.

In one implementation, request module 1308 directs processing system 1303 to receive a request from a new user to join the social media service. This request may be generated at a user device using an application specific to the service or may comprise a browser directed to a website supporting the service. In response to the request, generate module 1309 directs processing system 1303 to generate a profile for the user, wherein the profile comprises attributes or traits associated with the user. These attributes may include the name of the user, the school that the user graduated from, a current geographic location for the user, a current job position of the user, interests of the user, or some other similar attribute, including combinations thereof. In at least one implementation, to define the initial attributes for the profile, generate module 1309 may provide a dialogue to the new user via the end user device. In particular, when the user requests to join the service, the service may provide the user with questions that permit the user to answer using natural language. These natural language responses may then be used in developing the profile. For example, a question from computing system 1300 may include. “where did you graduate from college?” Once the question is provided, the user may answer using a keyboard or microphone on the end user device. In some examples, in providing the response, an autofill mechanism may be employed, wherein the autofill may suggest answers to the questions being proposed by generate module 1309. These autofill suggestions may be based on other members of the service that have already answered the questions, or may be based on information that the service has collected from one or more other public services that the user belongs.

Once the answers are provided by the user, a profile may be generated that can be presented to other members of the social network. In addition to the profile, generate module 1309 directs processing system 1303 to allocate the new user to one or more previously created member groups based on the attributes defined for the user profile. These groups may be created based on the school of graduation for the user, the current job title of the user, the current work organization or company for the user, the current location of the user, or some other similar attribute determined through the generation of the profile, including combinations thereof. For example, a user may be allocated to a defined group that is based on the current location and the school of graduation.

Although the first set of questions may be used to develop the initial profile of the end user, generate module 1309 may also be used to provide a settings menu, wherein the user may add, delete, or modify the profile information as details change or more information is required. These setting may permit the user to change a job title when required, add additional information about previous places of employment, or provide any additional information for the profile, wherein the information may also be used to place the user into existing communication groups. Further, the settings menu may be used to link other social media accounts and modes of communication to the user profile in the social media service.

In addition to generate module 1309, service module 1310 may, when executed by processing system 1303, direct processing system 1303 to provide various services to the user of the social media service. These services may include chat services, profile viewing services, suggested persons to communicate with, among other possible services. In at least one example, service module 1310 may direct processing system 1303 to provide a chat platform for users associated with the same groups. For example, a chat platform may be provided for all users that graduated from the same university and live within the same geographic region. Within the chat platform, the user may share text messages, images, videos, or some other similar type of media. Further, although the user may be allocated to an initial set of groups when joining the network, service module 1310 may permit a user to define and generate a new user group.

To generate the group, service module 1310 may direct processing system 1303 to receive a request from a first user to generate a new user group. In response to the request, the first user may be provided with a plurality of attributes associated with the first user (attributes defined within the user's profile), and may receive a selection of one or more attributes from the plurality of attributes. Once the selection is made of the one or more attributes, social media computing system 1300 may identify one or more other users in the social media service associated with the one or more attributes, receive a message from the first user to confirm the generation of the new user group, and provide the message to the one or more other identified users to create the new user group.

In some examples, in addition to or in place of users being permitted to create new groups, social media computing system 1300 may be configured to automate the operations of creating a new group. To provide this operation, service module 1310 may direct processing system 1303 to monitor profile attributes for the various users of the social media service. While monitoring the attributes, service module 1310 may identify two or more users that share at least one attribute, and may determine whether or not the two or more users should qualify for a new group. To make this determination, service module 1310 may identify whether the two or more users meet group generation criteria, wherein the criteria may comprise a required quantity of users to generate a new group, an amount of activity from the users to create the new group, an amount of recent interactions between the users to create the new group, or some other group generation criteria, including combinations thereof. In at least one implementation, social media computing system 1300 may monitor the messages that are being transferred between the users and identify common topics of the users. Accordingly, if the two or more users that share attributes also frequently communicate about the same common topics, then a new group may be generated to enhance the users' ability to communicate about the common topics. If it is determined that the two or more users meet the group criteria, then a new group may be generated and the users may be notified of the new group creation.

As an illustrative example, a group of users may be identified as a potential new group that are mechanical engineers and are located in the same geographic region. Once the group is identified, social media computing system 1300 may determine if the communications from the users meet communication criteria, such as if the communications typically target the same topics. If the communications of the potential members of the new group are about the same topics, then social media computing system 1300 may generate a new group and notify the users that qualify for the new group. In contrast, if the communications are not about the same topics, then social media computing system 1300 may refrain from generating the new group. Although this is just one example, it should be understood that any of the group generation criteria described herein may be used to determine if two or more users that share attributes should be classified as a new group.

Returning to the elements of social media network environment 100 of FIG. 1. Social media service 103 can include communication interfaces, network interfaces, processing systems, computer systems, microprocessors, storage systems, storage media, or some other processing devices or software systems, and can be distributed among multiple devices. Examples of social media service 103 can include software such as an operating system, logs, databases, utilities, drivers, natural language processing software, networking software, and other software stored on a computer-readable medium. Social media service 103 may comprise, in some examples, one or more server computing systems, desktop computing systems, laptop computing systems, or any other computing system, including combinations thereof.

Device 102 can be a user device, subscriber equipment, customer equipment, access terminal, smartphone, personal digital assistant (PDA), computer, tablet computing device, e-book, Internet appliance, media player, game console, or some other user communication apparatus, including combinations thereof. Device 102 can include communication interfaces, network interfaces, processing systems, computer systems, microprocessors, storage systems, storage media, or some other processing devices or software systems.

Communication link 120 can use metal, glass, optical, air, space, or some other material as the transport media. Communication link 120 can use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication link 120 can be a direct link or can include intermediate networks, systems, or devices, and can include a logical network link transported over multiple physical links. Although one main link for communication link 120 is shown in FIG. 1, it should be understood that link 120 is merely illustrative to show communication modes or access pathways. In other examples, further links can be shown, with portions of the further links shared and used for different communication sessions or different content types, among other configurations. Communication link 120 can include many different signals sharing the same associated link, as represented by the associated lines in FIG. 1, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

Although not illustrated in the example of FIG. 1, it should be understood that each member of social media service 103 may communicate with the social media service in a similar manner to that of new member 110 and device 102. In particular, the other members may use mobile devices, desktop computing systems, and the like to retrieve required information and access services provided by social media service 103.

Despite not being illustrated in FIGS. 1-13, in some implementations, a social media service may be used to provide multiple applications to the individual end users. As described herein, to access the social media service, users at end user devices may use an application specific to the social media service. In some examples, rather than providing a single application, multiple applications may be provided that permit the user to access specific groups based on an attribute of the user. For instance, the user may use an application that is specific to a school of graduation, and receive the groups and users associated with that school of graduation. Additionally, the user may use an application specific to a company that the user works for, and be provided with groups and users associated with the particular company. This permits the user to individually access portions of the social media service that are specific to an area of interest.

In some implementations, to provide the applications, the user may access an application store, such as the Apple App Store or the Google Play App store, and download applications of interest to their end user device. Once downloaded and installed, the user may register for the particular application, which may include entering an email address, a username, or some other similar information to verify the user's ability to use the application. For example, to join a school application, the user may be required to provide an email address with the domain name for the school. Once verified, a profile may be generated, wherein the profile may be generated using the exchange of dialogue questions as described herein for the social media service, or may include information gathered from other applications associated with the social media service. For example, when the user joins a school of graduation application, the user may import or join a profile that the user is using for another application in the social media service. Thus, instead of entering information for each of the applications, the user may import the information from other applications, and add any desired additional profile information.

Once joined in multiple applications, a user may then select the desired installed application and communicate with groups and users that are exclusive to that particular application. Accordingly, using the example of a school of graduation or current school, the user may only communicate with other groups and users that are associated with that particular school. In contrast, if the user were in a work group associated with a particular company, the user would only be able to communicate with groups and users associated with the work group.

Although individual applications may be provided, it should be understood that, in some examples, an overarching application may be provided in place of or in addition to the individual applications. This may permit groups and users that do not qualify the same application to communicate. Thus, although a specific application may not exist for chief executive officers in a particular geographic region, the user may use the overarching application to create and/or communicate with other chief executive officers in a particular geographic region.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a social media service to generate new user groups, the method comprising:
receiving a request from a first user to generate a new user group;
providing the first user with a plurality of attributes associated with the first user;
receiving a selection of one or more attributes from the plurality of attributes;
identifying one or more other users in the social media service associated with the one or more attributes;
receiving a message from the first user to confirm the generation of the new user group; and
providing the message to the one or more other users to create the new user group.

2. The method of claim 1, wherein the message comprises one of a text message, an image, or a video.

3. The method of claim 1, wherein the plurality of attributes comprises at least job position attributes, education history attributes, and location attributes.

4. The method of claim 1, further comprising:
determining whether the selection of the one or more attributes qualifies for a previously generated group;
if the selection of the one or more attributes qualifies for a previously generated group, providing the first user with a messaging user interface for the previously generated group; and
if the selection of the one or more attributes fails to qualify for a previously generated group, identifying the one or more other users in the social media service associated with the one or more attributes, receiving the message from the first user to confirm the generation of the new user group, and providing the message to the one or more other users to create the new user group.

5. The method of claim 1 further comprising, prior to receiving the message from the first user to confirm the generation of the new user group, indicating to the first user a quantity of users that qualify for the new user group.

6. The method of claim 5, wherein indicating to the first user the quantity of users that qualify for the new user group comprises suggesting one or more additional attributes be selected by the first user based on the quantity of users that qualify for the new user group.

7. The method of claim 5 further comprising:
after indicating to the first user the quantity of users that qualify for the new user group, receiving a selection of one or more additional attributes from the plurality of attributes;
identifying a subset of the one or more other users in the social media service associated with the one or more attributes and the one or more additional attributes,
wherein providing the message to the one or more other users to create the new user group comprises providing the message to the subset of the one or more other users in the social media service.

8. The method of claim 1 further comprising receiving a second message from a second user in the one or more other users and providing the second message to other members of the new user group.

9. The method of claim 8, wherein the second message from the second user comprises a response to the message from the first user, and wherein providing the second message to the other members of the new user group comprises providing the second message to the other members of the new user group comprises providing the second message to the other members of the new user group with an indication that the second message is in response to the message from the first user.

10. The method of claim 1, wherein the plurality of attributes associated with the first user comprise attributes defined by the first user in generating a user profile for the first user.

11. A computing apparatus comprising:
one or more computer readable storage media;
a processing system operatively coupled with the one or more computer readable storage media; and
program instructions stored on the one or more computer readable storage media to operate a social media service that, when read and executed by the processing system, direct the processing system to at least:
receive a request from a first user to generate a new user group;
provide the first user with a plurality of attributes associated with the first user;
receive a selection of one or more attributes from the plurality of attributes;
identify one or more other users in the social media service associated with the one or more attributes;
receive a message from the first user to confirm the generation of the new user group; and
provide the message to the one or more other users to create the new user group.

12. The computing apparatus of claim 11, wherein the message comprises one of a text message, an image, or a video.

13. The computing apparatus of claim 11, wherein the plurality of attributes comprises at least job position attributes, education history attributes, and location attributes.

14. The computing apparatus of claim 11, wherein the program instructions direct the processing system to:
determine whether the selection of the one or more attributes qualifies for a previously generated group;
if the selection of the one or more attributes qualifies for a previously generate group, provide the first user with a messaging interface for the previously generated group; and
if the selection of the one or more attributes fails to qualify for a previously generated group, identify the one or more other users in the social media service associated with the one or more attributes, receive the message from the first user to confirm the generation of the new user group, and provide the message to the one or more other users to create the new user group.

15. The computing apparatus of claim 11, wherein the program instructions direct the processing system to, prior to receiving the message from the first user to confirm the generation of the new user group, indicate to the first user a quantity of users that qualify for the new user group.

16. The computing apparatus of claim 15, wherein the program instructions to indicate to the first user the quantity of users that qualify for the new user group direct the processing system to suggest one or more additional attributes be selected by the first user based on the quantity of users that qualify for the new user group.

17. The computing apparatus of claim 15, wherein the program instructions direct the processing system to:
after indicating to the first user the quantity of users that qualify for the new user group, receive a selection of one or more additional attributes from the plurality of attributes;
identify a subset of the one or more other users in the social media service associated with the one or more attributes and the one or more additional attributes, and
wherein the program instructions to provide the message to the one or more other users to create the new user group direct the processing system to provide the message to the subset of the one or more other users in the social media service.

18. The computing apparatus of claim 11, wherein the program instructions direct the processing system to receive a second message from a second user in the one or more other users and provide the second message to other members of the new user group.

19. The computing apparatus of claim 18, wherein the second message from the second user comprises a response to the message from the first user, and wherein the program instructions to provide the second message to the other members of the new user group direct the processing system to provide the second message to the other members of the new user group with an indication that the second message is in response to the message from the first user.

20. The computing apparatus of claim 11, wherein the plurality of attributes associated with the first user comprise attributes defined by the first user in generating a user profile for the first user.

21. A method of operating a social media service to generate new user groups, the method comprising:
monitoring a plurality of attributes associated with users of the social media service;
identifying two or more users that share one or more attributes in the plurality of attributes;
determining whether the two or more users meet group generation criteria; and
if the two or more users meet the group generation criteria, generating a new user group for the one or more users.

22. The method of claim 21, wherein determining whether the two or more users meet the group generation criteria comprises identifying a quantity of the two or more users and determining whether the quantity exceeds a quantity threshold.

23. The method of claim 21, wherein the plurality of attributes comprises at least job position attributes, education history attributes, and location attributes.

24. The method of claim 21 further comprising transferring a notification to the two or more users.

25. The method of claim 24 further comprising receiving a message from a first user in the new user group and providing the message to other users in the new user group.
